(19) United States
(12) Patent Application Publication
(10) Pub. No.: US 2015/0063185 A1
(43) Pub. Date: Mar. 5, 2015

(54) MOBILE DEVICE AND METHOD FOR CONTROLLING FAST DORMANCY FUNCTION OF MOBILE DEVICE

(71) Applicant: Chiun Mai Communication Systems, Inc., New Taipei (TW)

(72) Inventor: WEI-YING HUANG, New Taipei (TW)

(21) Appl. No.: 14/473,090

(22) Filed: Aug. 29, 2014

(30) Foreign Application Priority Data
Aug. 30, 2013 (CN) 2013103858772

(51) Int. Cl. H04W 52/02; H04W 76/04

(52) U.S. Cl. CPC H04W 52/0225; H04W 76/04
USPC 370/311

(57) ABSTRACT

In a method for controlling a fast dormancy function of a mobile device, the method detects whether the mobile device is in an operating mode or in an idle mode. When the mobile device is in the operating mode, the fast dormancy function of the mobile device is disabled. When the mobile device is in the idle mode, the method determines whether one or more data packets are transmitted between a base station and the mobile device. When one or more data packets are transmitted between the mobile device and the base station, the fast dormancy function of the mobile device is enabled after a predetermined time interval.

### CROSS-REFERENCE TO RELATED APPLICATIONS

This application claims priority to Chinese Patent Application No. 201310385877.2 filed on Aug. 30, 2013, the contents of which are incorporated by reference herein.

### FIELD

Embodiments of the present disclosure relate to fast dormancy technology, and more specifically to a mobile device and a method for controlling a fast dormancy function of the mobile device.

### BACKGROUND

Fast dormancy is usually enabled in a mobile device for increasing battery life of the mobile device by limiting signaling traffic between a base station and the mobile phone. However, efficiency in transmitting data can be affected when a fast dormancy function of the mobile device is enabled during a data transmission.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a mobile device including a control system.

FIG. 2 illustrates a flowchart of one embodiment of a method for controlling a fast dormancy function of the mobile device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

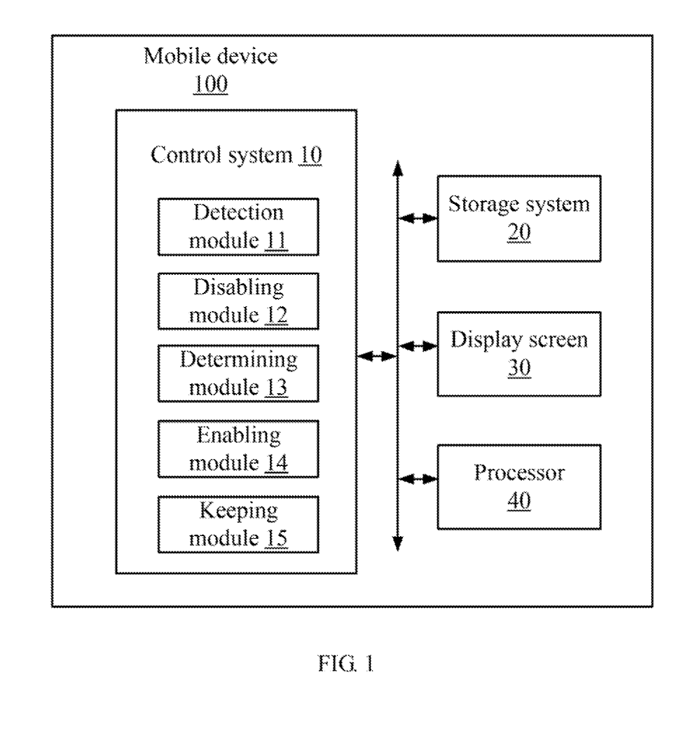

FIG. 1 illustrates a block diagram of one embodiment of a mobile device 100. Depending on the embodiment, the mobile device 100 includes a control system 10. In one embodiment, the mobile device 100 can be a personal digital assistant device, a mobile phone, or any other mobile device which has a feature called fast dormancy or an equivalent. The mobile device 100 further includes, but is not limited to, a storage system 20, a display screen 30, and at least one processor 40. The display screen 30 displays data of the mobile device 100.

In at least one embodiment, the storage system 20 can include various types of non-transitory computer-readable storage media. For example, the storage system 20 can be an internal storage system, such as a flash memory, a random access memory (RAM) for temporary storage of information, and/or a read-only memory (ROM) for permanent storage of information. The storage system 20 can also be an external storage system, such as a hard disk, a storage card, or a data storage medium. The at least one processor 40 can be a central processing unit (CPU), a microprocessor, or other data processor chip that performs functions of the mobile device 100.

In at least one embodiment, the control system 10 can include a detection module 11, a disabling module 12, a determining module 13, an enabling module 14, and a keeping module 15. The function modules 11-15 can include computerized code in the form of one or more programs, which are stored in the storage system 20. The at least one processor 40 executes the computerized code to provide functions of the function modules 11-15.

The detection module 11 is configured to detect whether the mobile device 100 is in an operating mode or in an idle mode. In one embodiment, if the mobile device 100 is in the operating mode, the mobile device 100 is being used by a user. If the mobile device 100 is in the idle mode, the mobile device 100 is not being used by the user. The idle mode is defined as a mode of the mobile device 100 when the mobile device 100 is powered on but the display screen 30 is off. The detection of whether the mobile device 100 is in the operating mode or in the idle mode is determined by whether the display screen 30 of the mobile device 100 is illuminated or not illuminated. When the mobile device 100 is in the operating mode, the display screen 30 is activated by operations of the user, and the display screen 30 is illuminated. When the mobile device 100 is in the idle mode, the display screen 30 is not illuminated.

In the embodiment, when the display screen 30 is illuminated, the detection module 11 determines that the mobile device 100 is in the operating mode. When the display screen 30 is not illuminated, the detection module 11 determines that the mobile device 100 is in the idle mode.

The disabling module is configured to disable a fast dormancy function of the mobile device 100 when the mobile device 100 is in the operating mode. In the embodiment, the fast dormancy function of the mobile device 100 is enabled in initial activation of the mobile device 100. When the mobile device 100 is in the operating mode, a reaction speed of network utilized by the mobile device 100 is a greater priority than saving battery life of the mobile device 100, and then the fast dormancy function of the mobile device 100 is disabled for faster network activity for the mobile device 100.

In one embodiment, when the fast dormancy function of the mobile device 100 is disabled and the mobile device 100 is in the operating mode, the mobile device 100 may not always be in a mode for data transmission. The mode for data transmission can be a CELL_FACH or CELL_DCH mode to which radio resource control (hereinafter abbreviated as “RRC”) links in the mobile device 100. When no data is transmitted between a base station and the mobile device 100 in a default time interval (e.g. two minutes), the mobile device 100 is switched to a mode that is not for data transmission according to a presetting by an Internet Service Provider. The mode that is not for data transmission can be an idle or CELL_PCH mode to which the RRC of the mobile device 100 creates a link. The mode that is not for data transmission saves battery life of the mobile device 100.

The determining module 13 is configured to determine whether one or more data packets are transmitted between the mobile device 100 and the base station when the mobile device 100 is in the idle mode. The base station can send data packets to the mobile device 100 and the mobile device 100 can send data packets to the base station.

The enabling module 14 is configured to enable the fast dormancy function of the mobile device 100 after a predetermined time interval when one or more data packets are transmitted between the mobile device 100 and the base station. The predetermined time interval is a factory preset or user-determined based on transmission performance of the mobile device 100, for example, three seconds. The predetermined time interval is a time interval for transmitting the data packets. When the mobile device 100 is in the idle mode, saving battery life of the mobile device 100 is a higher priority than fast networking of the mobile device 100, thus the fast dormancy function of the mobile device 100 is enabled for saving battery life of the mobile device 100.

The keeping module 15 is configured to disable the fast dormancy function of the mobile device 100 when the mobile device 100 is in the idle mode and no data packets are transmitted between the mobile device 100 and the base station. The fast dormancy function of the mobile device 100 saves battery life of the mobile device 100 by decreasing network congestion between the mobile device 100 and the base station, thus the fast dormancy function of the mobile device 100 does not need to be enabled when no data packets are transmitted between the mobile device 100 and the base station.

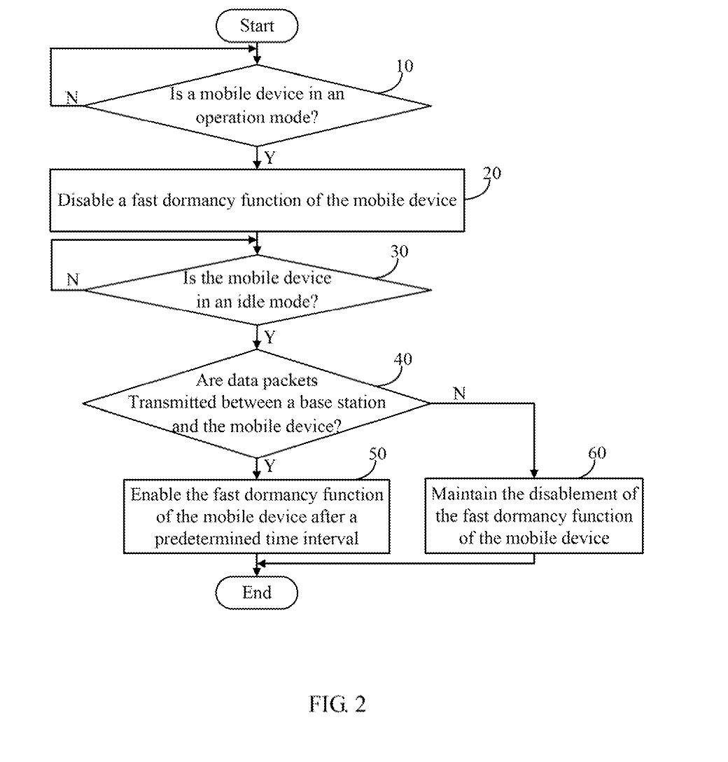

Referring to FIG. 2, a flowchart is presented in accordance with an example embodiment. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods, or subroutines, carried out in the exemplary method. Additionally, the illustrated order of blocks is by example only and the order of the blocks can be changed. The exemplary method can begin at block 10. Depending on the embodiment, additional blocks can be added, others removed, and the ordering of the blocks can be changed.

In block 10, a detection module detects whether a mobile device is in an operating mode or in an idle mode. When the operating mode of the mobile device is detected, block 20 is executed. When the mobile device is in the idle mode, block 10 is continually repeated. In one embodiment, when a display screen of the mobile device is illuminated, the detection module determines that the mobile device is in the operating mode. When the display screen is not illuminated, the detection module determines that the mobile device is in the idle mode.

In block 20, a disabling module disables a fast dormancy function of the mobile device when the mobile device is in the operating mode. In the embodiment, the fast dormancy function of the mobile device is enabled in initial activation of the mobile device.

In block 30, the detection module detects whether the mobile device is in the idle mode. When the mobile device is in the idle mode, block 40 is executed. As long as the mobile device is in the operating mode, block 30 is continually repeated.

In block 40, a determining module 13 determines whether one or more data packets are transmitted between a base station and the mobile device. When one or more data packets are transmitted between the mobile device and the base station, block 50 is executed. When no data packets are transmitted between the mobile device and the base station, block 60 is executed.

In block 50, an enabling module enables the fast dormancy function of the mobile device after a predetermined time interval. The predetermined time interval is a factory preset or user-determined based on transmission performance of the mobile device, for example, three seconds. The predetermined time interval is a time interval for transmitting the data packets.

In block 60, a keeping module maintains the disablement of the fast dormancy function of the mobile device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling a fast dormancy function of a mobile device, the method comprising:
detecting whether the mobile device is in an operating mode or in an idle mode;
disabling the fast dormancy function of the mobile device when the mobile device is in the operating mode;
determining whether one or more data packets are transmitted between a base station and the mobile device when the mobile device is in the idle mode; and
enabling the fast dormancy function of the mobile device after a predetermined time interval when one or more data packets are transmitted between the mobile device and the base station.

2. The method according to claim 1, further comprising:
disabling the fast dormancy function of the mobile device when the mobile device is in the idle mode and no data packets are transmitted between the mobile device and the base station.

3. The method according to claim 1, further comprising:
detecting whether a display screen of the mobile device is illuminated or not illuminated.

4. The method according to claim 3, wherein the mobile device is detected in the operating mode when the display screen of the mobile device is illuminated.

5. The method according to claim 3, wherein the mobile device is detected in the idle mode when the display screen of the mobile device is not illuminated.

6. The method according to claim 1, wherein the mobile device is being used when the mobile device in the operating mode, and the mobile device is not being used when the mobile device is in the idle mode.

7. A mobile device for controlling a fast dormancy function of the mobile device, the mobile device comprising:
a processor; and
a storage system that stores one or more programs, when executed by the at least one processor, cause the at least one processor to:
detect whether the mobile device is in an operating mode or in an idle mode;
disable the fast dormancy function of the mobile device when the mobile device is in the operating mode;
determine whether one or more data packets are transmitted between a base station and the mobile device when the mobile device is in the idle mode; and
enable the fast dormancy function of the mobile device after a predetermined time interval when one or more data packets are transmitted between the mobile device and a base station.

8. The mobile device according to claim 7, wherein the one or more programs further cause the at least one processor to:
disabling the fast dormancy function of the mobile device when the mobile device is in the idle mode and no data packets are transmitted between the mobile device and the base station.

9. The mobile device according to claim 7, wherein the one or more programs further cause the at least one processor to:
detect whether a display screen of the mobile device is illuminated or not illuminated.

10. The mobile device according to claim 9, wherein the mobile device is detected in the operating mode when the display screen of the mobile device is illuminated.

11. The mobile device according to claim 9, wherein the mobile device is detected in the idle mode when the display screen of the mobile device is not illuminated.

12. The mobile device according to claim 7, wherein the mobile device is being used when the mobile device in the operating mode, and the mobile device is not being used when the mobile device is in the idle mode.

13. A non-transitory storage medium having stored thereon instructions that, when executed by a processor of a mobile device, causes the processor to perform a method for controlling a fast dormancy function of the mobile device, wherein the method comprises:
detecting whether the mobile device is in an operating mode or in an idle mode;
disabling the fast dormancy function of the mobile device when the mobile device is in the operating mode;
determining whether one or more data packets are transmitted between a base station and the mobile device when the mobile device is in the idle mode; and
enabling the fast dormancy function of the mobile device after a predetermined time interval when one or more data packets are transmitted between the mobile device and the base station.

14. The non-transitory storage medium according to claim 13, wherein the method further comprises:
disabling the fast dormancy function of the mobile device when the mobile device is in the idle mode and no data packets are transmitted between the mobile device and the base station.

15. The non-transitory storage medium according to claim 13, wherein the method further comprises:
detecting whether a display screen of the mobile device is illuminated or not illuminated.

16. The non-transitory storage medium according to claim 15, wherein the mobile device is detected in the operating mode when the display screen of the mobile device is illuminated.

17. The non-transitory storage medium according to claim 15, wherein the mobile device is detected in the idle mode when the display screen of the mobile device is not illuminated.

18. The non-transitory storage medium according to claim 13, wherein the mobile device is being used when the mobile device in the operating mode, and the mobile device is not being used when the mobile device is in the idle mode.
